(19) United States
(12) Patent Application Publication
(10) Pub. No.: US 2012/0117839 A1
(43) Pub. Date: May 17, 2012

(54) PICTURE-EXHIBITING DEVICE WITH AUDIO SYSTEM

(75) Inventors: Dar-Ming Chiang, Hsinchu City (TW); Shu-Ru Lin, Taichung City (TW); Shen-Lung Liang, Hsinchu City (TW); Tzu-Ju Lu, Hsinchu City (TW)

(73) Assignee: TAIWAN ELECTRETS ELECTRONICS CO., LTD., Hsinchu City (TW)

(21) Appl. No.: 13/048,908

(22) Filed: Mar. 16, 2011

(30) Foreign Application Priority Data
Nov. 12, 2010 (TW) 099138986

(51) Int. Cl. A47G 1/06; H04R 1/02

(52) U.S. Cl. 40/717; 381/333

(57) ABSTRACT

A picture-exhibiting device with an audio system which can be used to demonstrate paintings or photos. The picture-exhibiting device with an audio system includes a frame, a picture fixed on the frame, an electret speaker positioned on the backside of the picture, a fixer disposed at a back side of the picture, a back frame fixed on the frame, a cover covering part of the back frame and the electret speaker, a post amplifier coupling the electret speaker, and an audio signal provider coupling the post amplifier.

### BACKGROUND OF THE INVENTION

1. Field of the Invention

The present invention relates to a picture exhibiting device with an audio system, and more particularly to a picture exhibiting device which can play music and can be a decoration.

2. Description of the Prior Art

Currently, music becomes a big form of entertainment for people in daily life. Besides wanting a good music playing device, people also pay attention to the audio quality. For example, Dolby Digital is the common version containing up to six discrete channels of sound. It can provide surround sound that envelops the movie watching or music listening audience, making them feel like they're in the middle of the action or concert.

True surround sound formats rely on dedicated speakers that literally and physically surround the audience. Therefore, six speakers are needed to play Dolby Digital 5.1, for example, a pair of front speakers, a center speaker, a pair of rear speakers, and a subwoofer.

However, the sizes of the speakers are heavy and big, therefore, the speakers can only be disposed on the ground. As a result, space in the house is occupied by the speakers, and the housing decoration becomes messy.

### SUMMARY OF THE INVENTION

It is one of the objects of the present invention to provide a picture exhibiting device with an audio system in order to solve the above-mentioned prior art problems.

To these ends, according to one aspect of the present invention, the picture-exhibiting device with an audio system includes a frame, a picture fixed on the frame and a first electret speaker disposed at a backside of the picture.

The picture-exhibiting device with an audio system can combine with photos or paintings, therefore, the room space can be saved. Moreover, the picture-exhibiting device is easy to fix on any object, and has a nice appearance. Besides, it is most suitable for use in building a home theater.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 depicts a picture-exhibiting device with an audio system schematically according to a first preferred embodiment of the present invention.

FIG. 2 depicts a picture-exhibiting device with an audio system schematically according to a second preferred embodiment of the present invention.

FIG. 3 depicts a structure of the electret speaker schematically according to a preferred embodiment of the present invention.

FIG. 4 shows the application of the picture-exhibiting device with an audio system according to a preferred embodiment of the present invention.

### DETAILED DESCRIPTION

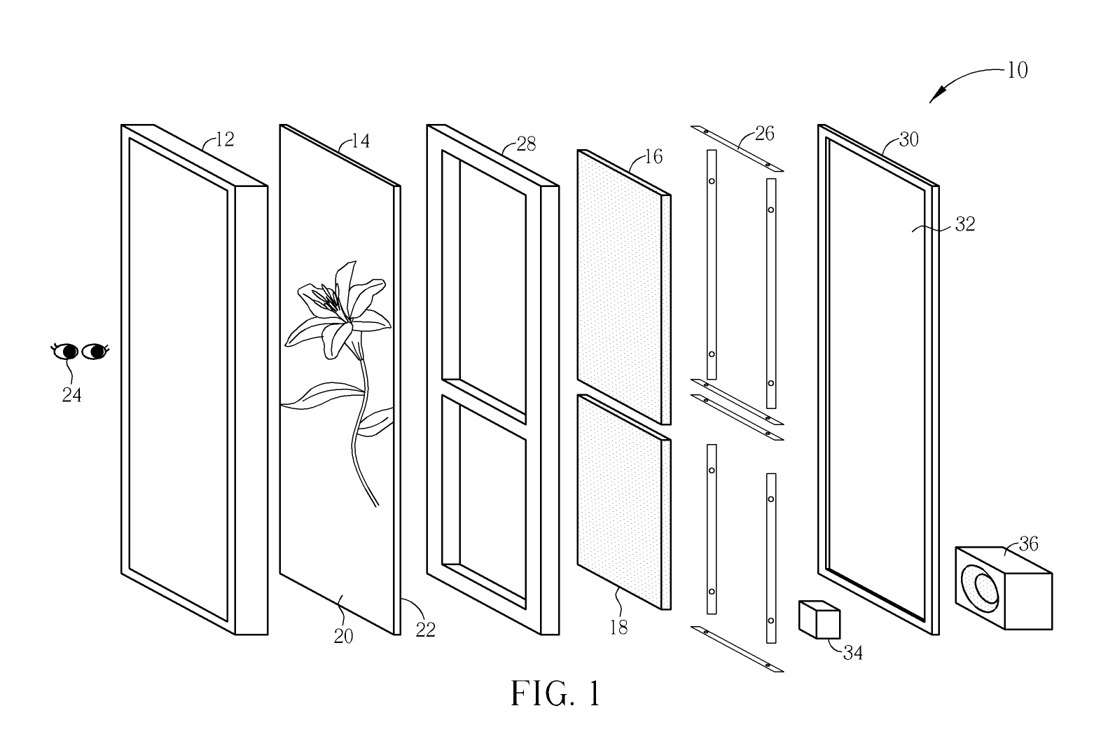

FIG. 1 depicts a picture-exhibiting device with an audio system schematically according to a first preferred embodiment of the present invention. As shown in FIG. 1, a picture-exhibiting device with an audio system 10 includes a frame 12, a picture 14 and at least one electret speaker 16. The picture-exhibiting device with an audio system 10 can display a painting or a photograph. More specifically speaking, the frame 12 can be a painting frame or a photo frame. The picture 14 can be a canvas, a paper, or a photograph. For example, the picture 14 can be an oil painting, a Chinese painting, a wafer painting, a colorful photo, or a black and white photo. FIG. 1 shows the picture-exhibiting device with audio system 10 displaying a painting. The picture 14 has a front side 20 and a back side 22. The front side 20 faces to an observer 24, and the back side 22 faces away from the observer 24. In addition, the picture 14 is fixed on the frame 12. The picture 14 can be a sound-penetrating material which can let sound pass through the material clearly. For example, the sound-penetrating material can be a canvas, a paper, a plastic punch plate or a cloth.

The electret speaker 16 can be fixed on the back side 22 of the picture 14 by a fixer 26 such as Velcro, double-sided tape or a hot-melt adhesive. However, because the electret speaker 16 is a film speaker, there must be enough air gap between the picture 14 and the electret speaker 16 or the picture 14 itself must be an air-permeable material. Otherwise, the electret speaker 16 will not have enough room to vibrate. Therefore, preferably, a spacer 28 can be optionally disposed on the back side 22 of the picture 14 to make sure the electret speaker 16 has enough room to vibrate. The electret speaker 16 can be fixed on the back side 22 of the spacer 28 by the fixer 26 such as Velcro, double-sided tape or a hot-melt adhesive. In another way, the electret speaker 16 can be fixed on the back side 22 of the spacer 28 by wood chips with a screw or plastic boards with a screw. The thickness of the spacer 28 can offer a proper distance to separate the electret speaker 16 and the picture 14. According to the first preferred embodiment, the proper distance is preferably between 0 cm to 3 cm. In this way, the electret speaker 16 has a proper vibration space.

Moreover, a back frame 30 can be fixed on the frame 12 and a cover 32 can be disposed on the back side 22 of the picture 14 to cover part of the back frame 30, the spacer 28 and the electret speaker 16. According to the first preferred embodiment, the thickness of the picture-exhibiting device with an audio system 10 is between 3 mm to 15 cm.

The electret speaker 16 needs to couple to a post amplifier 34 such as a converter. The post amplifier 34 couples to an audio signal provider 36. The post amplifier 34 may amplify the signal sent from the audio signal provider 36. The post amplifier 34 can be disposed between the spacer 28 and the cover 32. The audio signal provider 36 may be a DVD player, a CD player, an MP3 player, or a computer. The resistance of the post amplifier 34 is between 1Ω to 50Ω, and the conversion ratio of the post amplifier 34 is between 5 to 200. The input inductance of the post amplifier 34 is between 0.1 mH to 100 mH, and the output inductance of the post amplifier 34 is between 1 H to 100 H. The post amplifier 34 can also be covered by the back frame 30 and the cover 32.

The signals can transfer between the electret speaker 16, the post amplifier 34, and the audio signal provider 36 by wires, Bluetooth, or a wireless transmission module. In FIG. 1, the signal is transferred through wires.

It should be noted that there can be many speakers with different frequency ranges disposed at the back side 22 of the picture 14. For instance, the electret speaker 16 can be a low and medium frequency speaker with a frequency between 100 Hz to 12 KHz, and the capacitance of the electret speaker 16 is between 30 pF to 20 nF. Another electret speaker 18 which is a high frequency speaker can also be disposed at the back side 22 of the picture 14. The frequency of the electret speaker 18 is between 2 kHz to 30 KHz, and the capacitance of the electret speaker 18 is between 30 pF to 1 nF. The electret speaker 18 couples to the post amplifier 34 as well. With the electret speakers 16, 18, the picture-exhibiting device with an audio system provides a wider range of frequencies.

In addition, the number of the electret speakers 16 with the same frequency range can be more than one. Based on different requirements, numerous electret speakers 16 can be disposed at the back side 22 of the picture 14. For example, there can be three low and medium frequency speakers disposed at the back side 22 of the picture 14. In the same way, there can also be numerous high frequency speakers disposed at the back side 22 of the picture 14.

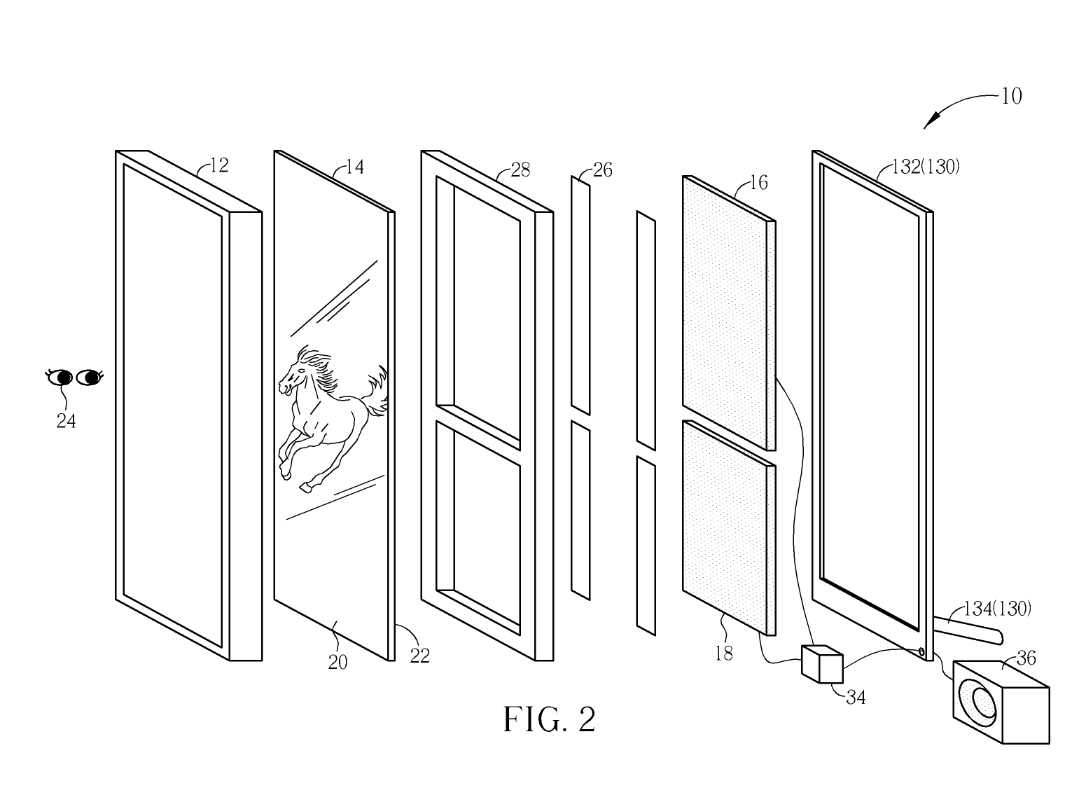

FIG. 2 depict a picture-exhibiting device with an audio system schematically according to a second preferred embodiment of the present invention, wherein like or similar features one to another will ordinarily be described with like reference numerals. The picture-exhibiting device with an audio system is utilized for displaying a photo. Most elements in the second preferred embodiment have like feature as that in the first preferred embodiment. Therefore, please refer to the first preferred embodiment for the description of the like elements in the second preferred embodiment. The difference between the first and the second preferred embodiments is that there is no back frame, but a supporter 130 on the picture-exhibiting device with an audio system 10 in the second preferred embodiment. The supporter 130 includes a frame 132 and a stand 134. Conventionally, the position of a conventional stand will block the sound. Therefore, in the present invention, the stand 134 is disposed at the bottom of the electret speaker 18. Furthermore, the post amplifier 34 is disposed outside of the picture-exhibiting device with audio system 10 rather than the space between the frame 12 and the supporter 130. Moreover, the signal between the electret speakers 16, 18, the post amplifier 34, and the audio signal provider 36 is transferred by Bluetooth.

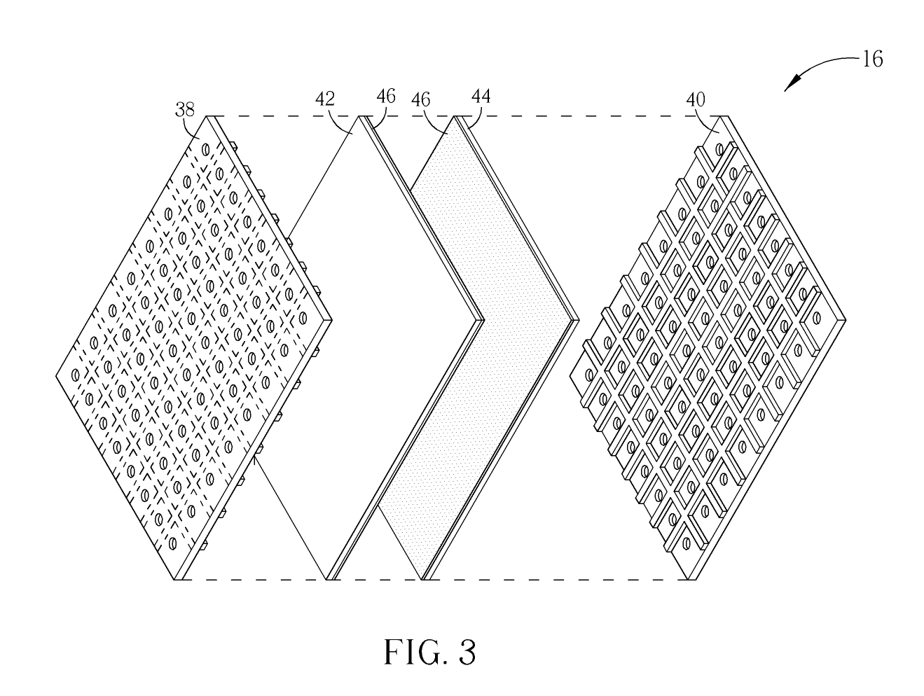

FIG. 3 depicts a structure of the electret speaker schematically according to a preferred embodiment of the present invention. As shown in FIG. 3, the electret speaker 16 includes a first electrode 38 and a second electrode 40 used for receiving an audio signal sending from the post amplifier 34. A first electret membrane 42 and a second electret membrane 44 are disposed between the first and the second electrodes 38, 40. A conductive layer 46 is disposed between the first electret membrane 42 and the second electret membrane 44. After the audio signal is input into the first electrode 38 and the second electrode 40, the first electret membrane 42, the second electret membrane 44 and the conductive layer 46 are driven to vibrate and make sounds. The capacitance of the electret speaker 16 is between 30 pF to 20 nF.

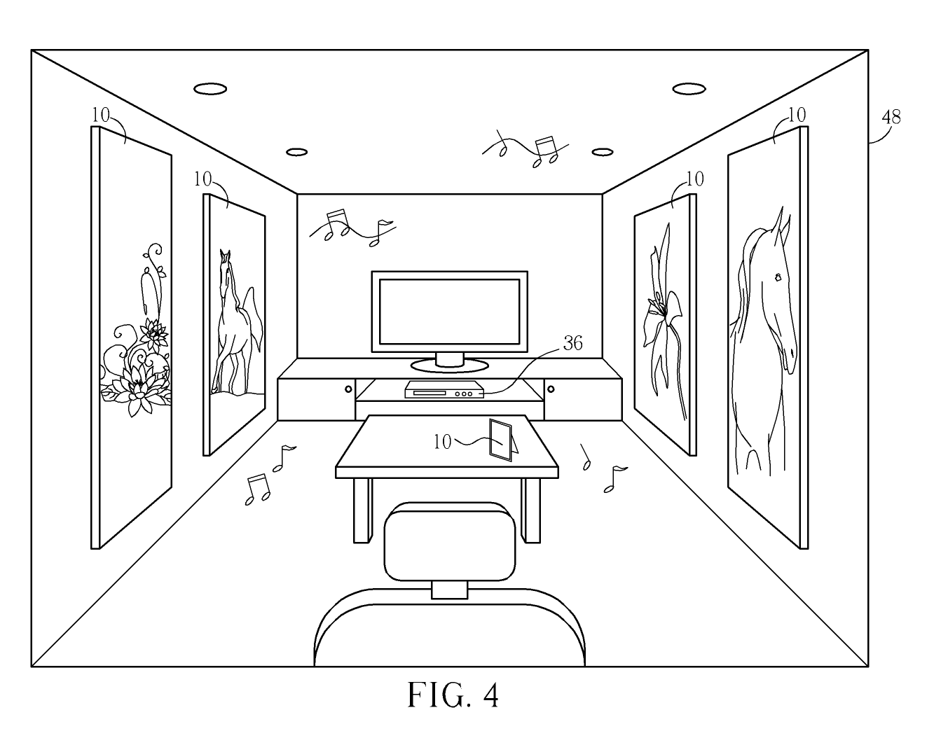

FIG. 4 shows the application of the picture-exhibiting device with audio system according to a preferred embodiment of the present invention. As shown in FIG. 4, numerous picture-exhibiting devices with audio system 10 are disposed in a space 48. Each picture-exhibiting device with an audio system 10 connects to the audio signal provider 36 by Bluetooth.

The electret speaker of the present invention is light and thin, therefore it's easy to fix on any object. Even when combined with the picture frames, the look of the picture frames is still beautiful. Besides, the observer can enjoy music when appreciating a picture. Moreover, the picture-exhibiting device with an audio system is space-saving. No more huge stereo set is needed. In addition, the electret speaker of the present invention can not only be combined with the picture frame but also with a screen, wall paper, or any other domestic decorations.

Those skilled in the art will readily observe that numerous modifications and alterations of the device and method may be made while retaining the teachings of the invention.

What is claimed is:

1. A picture-exhibiting device with an audio system, comprising:
a frame;
a picture fixed on the frame; and
a first electret speaker disposed at a backside of the picture.

2. The picture-exhibiting device with an audio system of claim 1, wherein the picture comprises a front side facing to an observer, and a back side facing away from the observer.

3. The picture-exhibiting device with an audio system of claim 1, wherein the frame comprises a photo frame or a painting frame.

4. The picture-exhibiting device with an audio system of claim 1, wherein the picture comprises a canvas, a paper, or a photo.

5. The picture-exhibiting device with an audio system of claim 1, further comprising a fixing element disposed at the back side of the picture for fixing the first electret speaker on the picture.

6. The picture-exhibiting device with an audio system of claim 5, wherein the fixer element comprises Velcro, double-sided tape or a hot-melt adhesive.

7. The picture-exhibiting device with an audio system of claim 5, wherein the fixer element comprises wood chips with a first screw or plastic boards with a second screw.

8. The picture-exhibiting device with an audio system of claim 1, wherein a distance is disposed between the first electret and the back side of the picture, and the distance is between 0 cm to 3 cm.

9. The picture-exhibiting device with an audio system of claim 1, wherein the thickness of the picture-exhibiting device with an audio system is between 3 mm to 15 cm.

10. The picture-exhibiting device with an audio system of claim 1, wherein the capacitance of the first electret speaker is between 30 pF to 20 nF.

11. The picture-exhibiting device with an audio system of claim 1, further comprising:
a back frame fixed on the frame; and
a cover covering part of the back frame and the first electret speaker.

12. The picture-exhibiting device with an audio system of claim 1, wherein the first electret speaker couples to a post amplifier.

13. The picture-exhibiting device with an audio system of claim 12, wherein the post amplifier couples to an audio generator.

14. The picture-exhibiting device with an audio system of claim 12, wherein the post amplifier is a converter.

15. The picture-exhibiting device with an audio system of claim 14, wherein the resistance of the converter is between 1Ω to 50Ω.

16. The picture-exhibiting device with an audio system of claim 14, wherein a conversion ratio of the converter is between 5 to 200.

17. The picture-exhibiting device with an audio system of claim 14, wherein the input inductance of the converter is between 0.1 mH to 100 mH.

18. The picture-exhibiting device with an audio system of claim 14, wherein the output inductance of the converter is between 1 H to 100 H.

19. The picture-exhibiting device with an audio system of claim 1, further comprising a second electret speaker.

20. The picture-exhibiting device with an audio system of claim 19, wherein the second electret speaker is a high frequency electret speaker, and the frequency of the second electret speaker is between 2 kHz to 30 KHz.

21. The picture-exhibiting device with an audio system of claim 20, wherein the capacitance of the second electret speaker is between 30 pF to 1 nF.

22. The picture-exhibiting device with an audio system of claim 1, wherein the first electret speaker is a low and medium frequency speaker, and the frequency of the first electret speaker is between 100 Hz to 12 KHz.

23. The picture-exhibiting device with an audio system of claim 22, wherein the capacitance of the first electret speaker is between 30 pF to 20 nF.

24. The picture-exhibiting device with an audio system of claim 1, wherein the picture is a sound-penetrating material.

25. The picture-exhibiting device with an audio system of claim 1, wherein the picture comprises a plastic punch plate, a cloth or a paper.
